(19) United States
(12) Patent Application Publication
(10) Pub. No.: US 2004/0014524 A1
(43) Pub. Date: Jan. 22, 2004

(54) Trivia and memory game using multimedia clips

(76) Inventor: Mark B. Pearlman, New York, NY (US)

Correspondence Address: R. Neil Sudol, 714 Colorado Avenue, Bridgeport, CT, 06605-1601, US

(21) Appl. No.: 10/390,212

(22) Filed: Mar. 17, 2003

Related U.S. Application Data
(60) Provisional application No. 60/365,553, filed on Mar. 18, 2002.

(51) Int. Cl. A63F 13/00

(52) U.S. Cl. 463/30

(57) ABSTRACT

An interactive multimedia trivia and memory game involves the presentation, to multiple players or a single player, of multimedia clips including a visual component and optionally an audio component. The visual component may be a video clip, a photo, an animation, or a table. Each multimedia clip is associated with a plurality of potential questions. During at least one kind of play format, a multimedia clip is randomly selected for presentation to the players. Thereafter, a question is randomly selected, and presented to the players, from among the potential questions associated with the selected multimedia clip. The players accumulate or lose points depending on the correctness or incorrectness of their responses to the presented questions. The amount of points is dependent on how quickly the player responds.

### BACKGROUND OF THE INVENTION

This invention relates to a game. More particularly, this invention relates to an interactive trivia and memory game with video game features.

### SUMMARY OF THE INVENTION

The present invention is directed to an innovative multimedia trivia and memory game that may be played in a variety of settings. The game may, for instance, be adapted as a videogame for the Sony PlayStation2 for Microsoft's X-Box or other platform. Alternatively, the game may be implemented via the Internet and personal computers. In another embodiment, the game takes the form of a television game show.

The game typically involves the presentation, to multiple players, of multimedia clips including a visual component and usually, but not necessarily, an audio component. The game can also be played with one participant. The visual component may be a video clip, a photo, an animation, or a table. Each multimedia clip is associated with a plurality of potential questions. During at least one kind of play format, a multimedia clip is randomly selected for presentation to the players. Thereafter, a question is randomly selected, and presented to the players, from among the potential questions associated with the selected multimedia clip. The players accumulate or lose points depending on the correctness or incorrectness of their responses to the presented questions.

Preferably, the points are characterized in a form indicative of brain size or function. For instance, the points may be called “dendrites.” A player loses or acquires dendrites to the extent that the player is unsuccessful or successful at answering the presented questions. Accordingly, a successful player will be assigned more “dendrites” than a less successful player.

In a particular embodiment of the present invention, the game combines interesting, edgy video clips with provocative and challenging questions in a fast-paced, witty setting. These clips span subjects and years, and cover the interesting pop culture topics such as popular movies, memorable news events, and exciting sports moments. The associated questions may directly pertain to the content of the movies, news events, or sports moments of the multimedia clips. Or the questions might pertain to persons, events, and information connected to the production of the movies, news events, or sports moments. Alternatively, the questions might pertain to trivia only indirectly relating to the movies, news events, or sports moments. For instance, the players may be quizzed about other events occurring at the same time as, or having a common theme with, the subjects of the movies, news events, or sports moments. There may also be questions related to the specific scenes in the clip, in which the player is tested on what he actually saw or heard.

A multimedia trivia and memory game in accordance with the present invention may be presented in multiple rounds each employing a different game play that tests players' knowledge, recall, ability to think freely as well as hand/eye coordination through intriguing sights, sounds and questions. In a first type of round, all of the players are competing simultaneously, and the player that controls the question has the first opportunity to answer a question correctly. That player continues until he or she answers a question incorrectly. At that juncture, the other players compete simultaneously with each other to answer that one question correctly. In any case, a winning answer results in an accumulation of dendrites for the player with that answer.

In the first type of round, a predetermined number of questions are presented. In a second type of round, the round begins with a video and each player quickly tries to verify whether an answer is correct or incorrect. All players who correctly answer a question may enjoy an increase in their respective dendrites, with the increases being proportional to the quickness of responses. In addition, those players who answer incorrectly might lose dendrites.

In a third type of round, the player with the most dendrites accumulated in the first two rounds is presented with a new multimedia clip. The player accumulates dendrites with each correct answer but loses al dendrites upon answering incorrectly. The player cannot opt out of this round until he has answered all of the questions in the round.

The questions may be presented in suitable format. One preferred format is the multiple-choice question. This format facilitates the automatic tracking of answers and the automatic tabulation of dendrites. Thus, where the multimedia trivia game is implemented as a video game, each video game control includes a plurality of buttons or touch pad zones corresponding in number to the multiple-choice answers provided per question.

A multimedia game pursuant to the present invention contemplates an integration of video clips with interesting, engaging, entertaining questions. The game may include collage segments that span categories and innovatively reuse existing footage in new and interesting ways (e.g., athletes named John).

A multimedia game pursuant to the present invention is cost-effective through re-purpose of existing footage.

Video clips may be taken from movies, television shows, and music videos that have not yet been publicly released, thereby providing a promotional vehicle for film and music distribution companies.

The present invention provides the potential for endless extension including specialized niche areas such as Star Trek or segments such as the 60s Decade. The game cane also be done with one player. The participant competes against time and the quicker he responds in each round and question the more dendrites he can win or lose.

### BRIEF DESCRIPTION OF THE DRAWINGS

FIG. 1 is a block diagram of a system for executing an interactive multimedia trivia game in accordance with the present invention.

### DETAILED DESCRIPTION OF THE PREFERRED EMBODIMENTS

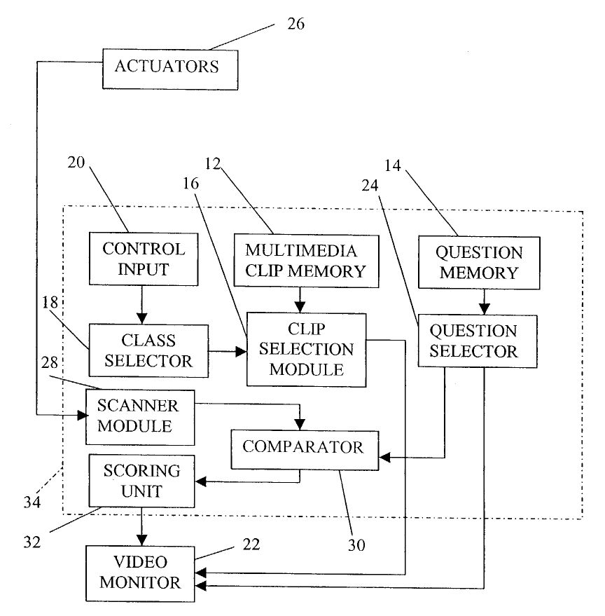

As illustrated in FIG. 1, an interactive multimedia trivia game system comprises a memory 12 storing a plurality of multimedia clips of respective subjects. Each of the multimedia clips includes at least a visual component and an audio component of related content. The visual component may be a video sequence, a photograph, a graphical representation, an animation, a table, etc. Memory 12 may also store a plurality of purely audio clips, for instance, excerpts of classical or popular music, motion picture sound tracks, television dialogue, etc.

For each of the stored multimedia clips stored in memory 12 there is stored, in memory 12 or in a separate memory 14, a multiplicity of questions on subject matter related to the respective multimedia clip. The questions may directly pertain to the content of the respective multimedia clips. For instance, in the case of movies, the questions may be about the plot, the characters, or the actors. In the case of news events, the questions may relate to the participants, the time, the place, or the action. In the case of sports events, the questions may concern the teams, the players names, positions, and statistics, the score, etc.

Alternatively, the questions stored in memory 12 or 14 pay pertain to persons, events, and information connected to the production or generation of the movies, news events, or sports moments. For instance, movie questions may involve the producers, directors, cinematographers, special effects employed, screen writers, etc., sports questions may contemplate the managers, owners, cities, etc., and news questions may be directed to events prior to and after the events depicted in the multimedia clips.

The questions associated with a multimedia clip might pertain to trivia only indirectly relating to the movie, news event, or sports moment embodied in the multimedia clip. Such questions may relate to other events occurring at the same time as, or having a common theme with, the subjects of the movies, news events, or sports moments.

As further illustrated in FIG. 1, memory 12 is connected to a selection module 16 operative to select a multimedia clip from among the clips stored in memory 12. The selection may be entirely random or partially random. In the latter case, a selection may be made from a particular class of clips, such as movies clips or sports clips, stored in memory 12. The selection of a class of clips may be made by selection module 16 in accordance with instructions from a class selector 18 in turn receiving signals from a control input 20.

Selection module 16 is operatively connected to a video monitor 22 for communicating at least a portion of the selected multimedia clip to a plurality of players. Video monitor 22 may be a television set, in the case of a video game implementation, or a computer monitor, in the case of an Internet implementation. Where the trivia game takes the form of a game show, video monitor 22 may be a projection screen.

Where the interactive multimedia trivia game system is a video game, the various components of the system including memories 12 and 14 and selection module 16 are located in part on the video game cartridge. Where the multimedia trivia game system is an Internet game, the various components of the system including memories 12 and 14 and selection module 16 may be located on a server computer remote from the user computers of the various players.

Upon the displaying of a selected multimedia clip on monitor 22, a question selector 24 connected to memory 14 (or 12) at least partially randomly selects a first question from among the questions stored for the displayed multimedia clip. Selector 24 is operatively connected to monitor 22 or to some other player interface device such as a loudspeaker or digital display (neither shown) for communicating the selected questions to the players.

The players have access to actuators 26 such as buttons for indicating an answer to the communicated question. A scanner module 28 monitors activation of the actuators 26 by the players to determine the answers of the players and, in the case of a head-to-head competition, the order in which the players answer. Scanner module 28 may incorporate a timer (not separately shown) for determining the lags between the communication of a question and the responses of the various players. Module 28 is operatively connected to a comparator module 30 which compares the players' answers with correct answers from memory 14 (or 12). Comparator 30 and module 28 are operatively connected to a scoring unit 32 which determines the players' scores in accordance with their correct and incorrect responses. Scores may be communicated to the players via video monitor 22.

The multimedia clips stored in memory 12 may have both a visual component and an audio component, only a visual component, or only an audio component. Video monitor 22 is associated with a loudspeaker (not separately shown) for communicating any audio component of a multimedia clip to the players. In any case, memory 14 (or 12) stores questions pertaining to the respective multimedia clips.

Memory 14 may additionally store a set of queries for each of at least some of the questions, the queries being related to the respective correct answer. Upon determining receipt of a correct response for one of the selected questions, comparator 30 induces question selector 24 to randomly select a query from among the queries stored for the question which was just answered. Question selector 24 communicates the selected query to at least one of the players via video monitor 22 or other output device. Scanner module 28 and comparator 30 then monitor the actions of one or more players to determine whether a correct response to the selected query has been given. Scoring unit 32 modifies the score of one or more players in accordance with the respective players' success at correctly answering the query.

The scores are communicated to the players as accumulations of “dendrites” or other measurement of brain size, function, and power.

Various components of the interactive multimedia trivia game system of the drawing may be implemented as a digital processor or computer 34.

### EXAMPLE 1

A first round of a video-clip trivia game, exemplarily called a Head-to-Head round, commences with a short edited 30-second video clip relating to the O. J. Simpson criminal-trial verdict where the jury found him not guilty in the murder of Nicole Brown Simpson. The selected video clip may, for instance, be a court room scene at the time the verdict is announced, showing the reactions of the family, friends, jurors, and attorneys. Alternatively, the video clip selected for presentation to the players may be the news footage of the car chase scene.

As the clip ends, the players are presented with a series of four quick questions about O. J. Simpson, the trial, other events that happened at the same time, and other topics that relate somehow, someway, to the displayed video-clip. For each question, the players are given four answers to choose from. Each player's task is to control the question and pick the right answer(s). For each correct answer, a player amasses “dendrites” (points) that increases the size and power of the respective player's brain. For each incorrect answer, the player loses dendrites and helps the other players by eliminating an incorrect answer.

Other clips cover a wide range of topics, illustratively including Richard Nixon's historic resignation speech, amusing antics from The Simpson's TV show, Neil Armstrong's Walk on the Moon, etc.

A second round of play, termed “The Bonus Round,” starts off with another 30-second video clip. In this round, there are four videos followed by fast paced questions and answers. You verify each answer for a particular question selecting it as either correct or incorrect with your keypad device. Each player competes and acts quickly to answer the question.

The player who led with the most dendrites in the first two rounds moves on to a third round, the BrainSqueezer round. This round consists of a single video clip and six questions. As the lead player correctly answers the questions, he or she wins more dendrites. If this lead player answers a question incorrectly, he or she loses all the dendrites won in this round.

Dendrites won in a game are passed into succeeding rounds.

An interactive multimedia trivia game as described hereinabove is extendible to a variety of different topics, time periods, question formats, etc., that can be either highly specific or general. In addition, expanding the offering enables the enterprise to be cost effective by allowing for reuse of licensed footage, sound stock, etc. Table 1 lists examples of games.

TABLE 1

| Title | Focus |
|---|---|
| BrainSqueeze ™ I: The Adventure Begins | All topics, decades, subjects |
| BrainSqueeze ™ Meets the NBA | NBA teams, players, high- |
| | lights |
| BrainSqueeze ™ Meets the Simpsons | Simpson's TV show charac- |
| | ters, stories, trivia |
| BrainSqueeze ™: You are Here The 80's: | 1980s events, moments, |
| The Me Generation | places |
| BrainSqueeze ™ Laffs | Current and classic comedy |
| | classics from television, |
| | movies, radio and clubs |
| BrainSqueeze ™ Goes Rock-n-Roll | Events, artists - precious and |
| | absurd, moments in |
| | rock-n-roll music |
| Extreme BrainSqueeze ™ | Ultimate and most challenging |
| | game |
| BrainSqueeze ™ You are Here: The 60's | 1960s events, issues, moments |
| BrainSqueeze ™ goes Country & Western | Events, issues, moments in |
| | Country and Western |
| Jr. BrainSqueeze ™ (7+) | All topics, time periods, |
| | places for kids |
| Holy BrainSqueeze ™ ! | People, places, events, in |
| | the Bible |
| BrainSqueeze ™ You Are Here: NYC | Characters, places, events in |
| | the Big Apple |
| BrainSqueeze ™ Inventions and Fads | Pop culture trends, popular |
| | items, gimmicks, etc. |
| BrainSqueeze ™: You Squeeze Us | Video parodies done by |
| | BrainSqueeze ™ following |
| BrainSqueeze ™: So You are in High | Life and times of a teenager |
| School | |
| BrainSqueeze ™: Love and Marriage | Lessons from fiction and |
| | nonfiction couples |
| BrainSqueeze ™ Goes to the Front Lines: | Civil War events, issues, |
| Civil War (or any war) | moments |
| BrainSqueeze ™ Goes Classical | Classical music, e.g., Mozart |
| BrainSqueeze ™ Meets the NFL | NFL teams, players, high- |
| | lights |
| BrainSqueeze ™: Heroes and Villains | Acclaimed heroes and noto- |
| | rious villains |
| BrainSqueeze ™ at the Galleries | Modern and classic art |
| BrainSqueeze ™: Fashion and Flair | Clothing, fashion, models |
| | including golfwear to |
| | bowling shirts to haute |
| | couture |

Each interactive multimedia trivia game includes a minimum number of multimedia clips, and a minimum number of questions per clip. One business advantage of the use of video clips is the ability to cost effectively access existing video footage through licensing. These arrangements can facilitate the offering of a broad range of products where there is some overlap in content across different products. Licensing arrangements are generally necessary for development and release of specific targeted products such as The Simpsons, the NBA, the NFL, etc.

The existence of public news archives ensures ample resources political news and events clips. The following list provides examples of footage that is accessible through Public News Archives:

Walk on the moon

Nixon resignation

O J Simpson Verdict

Kennedy inauguration speech

FDR speech on Pearl Harbor

Princess Diana's funeral

McCarthy hearings

Monkeys in space

Reagan inauguration and hostage release

Bill Clinton “I didn't have sexual relations” speech

Lindbergh Flight

McDonald's opening in Beijing

Brooklyn Bridge construction

Robert Frost reading poem

Dan Quayle spelling “potatoe”

Scopes trial

Mark Twain

Civil War

An interactive multimedia trivia game as contemplated herein may also include music clips. The following list includes sample music footage that might be t included in games:

Festivals: Live Aid, Farm Aid, Woodstock

Awards: Grammies

Beatles

Jimi Hendrix

Janis Joplin

Michael Jackson

U2

Ricky Martin

Bob Dylan

Madonna

Diana Ross

Whitney Houston

An interactive multimedia trivia game as contemplated herein may also include sports footage in a number of its games: basic games, time-focused games (Decades) and sports-focused games (e.g., NBA, NFL, etc.). The following is a list of example sports clips that could be included:

Baseball: Babe Ruth, Lou Gehrig, Joe Dimaggio

Olympics: Jesse Owens, Dream Team, Mary Lou Retton, Michael Jackson, Peggy Flemming, Dorothy Hamill, Picabo Street

Boxing: Mohammed Ali, George Foreman

Football: Joe Theisman, O J Simpson, Jim Brown, Joe Namath, Barry Saunders, Marshall Faulk, Doug Flutic, Jim Kelly, Bruce Smith

Hockey: Bobby Orr, Gil Pereault, Domenic Hasek

Basketball: Michael Jordan, Shaquille O'Neal,

Soccer: Mia Hamm, Pele

Tennis: Anna Kornikova, Venus Williams, Arthur Ashe, John MacEnroe, Jimmy Connors

Golf: Tiger Woods, Jack Nicholas

An interactive multimedia trivia game as contemplated herein may also include clips from popular television shows. The following list provides examples of shows for possible inclusion:

The Simpsons

I Love Lucy

Star Trek

Cheers

Seinfeld

MASH

Brady Bunch

In addition to straight video clips, an interactive multimedia trivia game as contemplated herein may also include collage clips that blend footage. These clips most often focus on a theme, rather than an individual, time period or event. The following lists example collage topics:

College fads: from streaking to goldfish to stuffing telephone booths

Hair Styles through the years

Great inventions

Things that move

Coca-Cola (or some other company who product places) through the years

Periodic table

Money from around the world

New York City celebration

London

Ancient Greece

Decade

Dinosaurs

Women heroes

Each interactive multimedia trivia game disk contains the following:

| | |
|---|---|
| Total video material | 25 minutes |
| Total distinct video clips | 60 clips |
| Distinct questions per clip | 40 questions per clip |
| Total questions | 2400 questions |

| | | Questions/ | Total |
|---|---|---|---|
| Round | Clip | clip | questions |
| Head to head | 4 | 4 | 16 |
| Bonus | 4 | 4 | 16 |
| BrainSqueezer | 1 | 6 | 6 |
| Total | 9 | | 38 |

Total number of games per disk: in excess of 60 (based on total number of questions for the clips). Where a group of multimedia or video clips are to be licensed for use in a specialized game, the license might also entail the use of the clips in a general game. This provides a built-in kind of promotion for users to acquire the specialized game where the users start with the general game. Thus, some of the video clips and still shots in a game dedicated the Simpsons or other television show would also be used in a general game where subjects other than television shows would also be included.

Although the invention has been described in terms of particular embodiments and applications, one of ordinary skill in the art, in light of this teaching, can generate additional embodiments and modifications without departing from the spirit of or exceeding the scope of the claimed invention. It is to be noted, for instance, that the method described herein is suitable for educational purposes. The use of the tern “game” to describe the method is not intended to restrict use of the invention to pure entertainment situations. Instead, a game as described herein may be used in an institutional setting as part of a heuristic program.

Accordingly, the drawings and descriptions herein are proffered to facilitate comprehension of the invention and not to limit or circumscribe the scope thereof.

What is claimed is:

1. A game method comprising:
storing a plurality of video clips of respective subjects;
storing, for each of the stored video clips, a multiplicity of questions on subject matter related to the respective video clip;
at least partially randomly selecting a video clip from among said stored video clips;
displaying at least a portion of the selected video clip to at least one player;
upon the displaying of said selected video clip, at least partially randomly selecting a plurality of questions from among the questions stored for said selected video clip;
communicating the selected questions one at a time to said player;
monitoring actions of said player to determine correct and incorrect responses of said player to said selected questions; and
maintaining a score for said player reflective of said player's success at correctly answering questions.

2. The method defined in claim 1 wherein the storing of said video clips and said questions is implemented electronically.

3. The method defined in claim 1 wherein said video clips pertain to subjects in a common field of interest.

4. The method defined in claim 1 wherein said video clips pertain to subjects in different fields of interest.

5. The method defined in claim 1 wherein at least some of said selected questions include a plurality of multiple-choice answers.

6. The method defined in claim 1 wherein the selecting of said selected video clips, the displaying of said selected video clip, the selecting of said selected questions, the communicating of said selected questions, the monitoring of said players, and the maintaining of the player score are all performed automatically under the control of an electronic processor.

7. The method defined in claim 1 wherein said stored video clips are taken at least in part from movie videos, television videos, sports videos, and news videos.

8. The method defined in claim 1 wherein at one of the selected questions has an answer, further comprising:
after the communicating of said one of said selected questions and a responding to said one of said selected questions to indicate said answer;
selecting a further question related to said answer;
communicating said further question to said player, monitoring actions of said player to determine correctness of a response of said player to said further question; and updating the score for said player reflective of said player's success at correctly answering said further question.

9. A game method comprising:
storing a plurality of multimedia clips of respective subjects, each of said multimedia clips including at least a visual component and an audio component of related content;
storing, for each of the stored multimedia clips, a multiplicity of questions on subject matter related to the respective multimedia clip;
at least partially randomly selecting a multimedia clip from among said stored multimedia clips;
communicating at least a portion of the selected multimedia clip to at least one player;
upon the displaying of said selected multimedia clip, at least partially randomly selecting a plurality of questions from among the questions stored for said selected multimedia clip;
communicating the selected questions one at a time to said player;
monitoring actions of said player to determine correct and incorrect responses of said player to said selected questions; and
maintaining a score for said player reflective of said player's success at correctly answering questions.

10. The method defined in claim 9 wherein the storing of said multimedia clips and said questions is implemented electronically.

11. The method defined in claim 9 wherein said multimedia clips pertain to subjects in a common field of interest.

12. The method defined in claim 9 wherein said multimedia clips pertain to subjects in different fields of interest.

13. The method defined in claim 9 wherein at least some of said selected questions include a plurality of multiple-choice answers.

14. The method defined in claim 9 wherein the selecting of said selected multimedia clips, the communicating of said selected multimedia clip, the selecting of said selected questions, the communicating of said selected questions, the monitoring of said players, and the maintaining of the player score are all performed automatically under the control of an electronic processor.

15. The method defined in claim 9 wherein said stored multimedia clips are taken at least in part from movies, television, sports, and news.

16. The method defined in claim 9 wherein at least some of said stored multimedia clips include a visual component taken from the group consisting of photos, animation, and tables.

17. The method defined in claim 9, further comprising:
storing a plurality of visual clips of respective subjects, each of said visual clips including only a visual component;
storing, for each of the stored visual clips, a multiplicity of queries on subject matter related to the respective visual clip;
at least partially randomly selecting a visual clip from among said stored visual clips;
communicating at least a portion of the selected visual clip to said player;
upon the displaying of said selected visual clip, at least partially randomly selecting a plurality of queries from among the queries stored for said selected visual clip;
communicating the selected queries one at a time to said player;
monitoring actions of said players to determine correct and incorrect responses of said player to said selected queries; and
maintaining the score for said player in part in accordance with correctness of the player's responses to said selected queries.

18. The method defined in claim 9 wherein said questions have respective correct answers, further comprising:
storing, for each of at least some of said questions, a set of queries related to the respective correct answer;
upon receiving a correct response for one of said selected questions, at least partially randomly selecting a query from among the queries stored for said one of said selected questions;
communicating the selected query to said player;
monitoring actions of said one of said players to determine correctness of a response of said player to said selected query; and
modifying the score of said player in accordance with the player's success at correctly answering said query.

19. The method defined in claim 9 wherein the score of said player is kept as an indicator of brain size and function.

20. The method defined in claim 19 wherein the scores are numbers of dendrites.

21. The method defined in claim 9 wherein the communicating of the selected multimedia clip portions to said player includes transmitting said selected multimedia clips portions via the Internet.

22. The method defined in claim 9 wherein the storing of said multimedia clips is implemented on video game storage media.
